(19) United States
(12) Patent Application Publication
(10) Pub. No.: US 2012/0289173 A1
(43) Pub. Date: Nov. 15, 2012

(54) INTERFACE OF MULTI CHIP MODULE

(75) Inventors: Kyoung Ho Lee, Gyeonggi-do (KR); Su Bong Jang, Gyeonggi-do (KR); Dong Hwan Lee, Gyeonggi-do (KR); Hee Soo Yoon, Seoul (KR)

(73) Assignee: SAMSUNG Electro-Machanics Co., Ltd.

(21) Appl. No.: 13/444,538

(22) Filed: Apr. 11, 2012

(30) Foreign Application Priority Data
May 9, 2011 (KR) 10-2011-0043529

(51) Int. Cl. H04B 1/44; H04B 1/40; H04B 1/04

(52) U.S. Cl. 455/83; 455/91; 455/90.2

(57) ABSTRACT

Disclosed herein is an interface of a multi chip module transmitting and receiving data among a plurality of chips. An interface of a multi chip module includes a communication unit that is provided in the chips and transmits and receives the data; and a radio communication unit that is provided outside the chips, converts the data transmitted from the communication unit into radio signals and wirelessly transmits the radio signals, and demodulates radio signals received from other chips into data and transmits the data to the communication unit, whereby wired communication chips can implement radio communication.

### CROSS REFERENCE(S) TO RELATED APPLICATIONS

This application claims the benefit under 35 U.S.C. Section 119 of Korean Patent Application Serial No. 10-2011-0043529, entitled “Interface of Multi Chip Module” filed on May 9, 2011, which is hereby incorporated by reference in its entirety into this application.

### BACKGROUND OF THE INVENTION

1. Technical Field

The present invention relates to an interface of a multi chip module, and more particularly, to an interface of a multi chip module communicating among a plurality of chips to transmit and receive data.

2. Description of the Related Art

Generally, a wired connection scheme connecting among a plurality of chips using a copper wiring has been used. However, there are problems in that the wired connection method as described above is difficult to maintain signal integrity as a transmission rate of data is increased and consumes a large amount of power.

In order to solve the above problems, the plurality of chips communicates with each other using a radio communication method rather than using a wired connection method using copper.

In order to practically use the radio communication method that communicates among the plurality of chips, all the transmitting and receiving chips are to be designed to wirelessly communicate with each other when the radio communication method is applied to a system.

However, it is really difficult to change the existing chips designed to be operated by the wired connection method to radio communication chips at the same time. Therefore, a need exists for a method of allowing the existing wired communication chips to transmit and receive radio signals.

### SUMMARY OF THE INVENTION

An object of the present invention is to provide an interface of a multi chip module capable of allowing wired communication chips to implement radio communication.

According to an exemplary embodiment of the present invention, there is provided an interface of a multi chip module transmitting and receiving data among a plurality of chips, including: a communication unit that is provided in the chips and transmits and receives the data; and a radio communication unit that is provided outside the chips, converts the data transmitted from the communication unit into radio signals and wirelessly transmits the radio signals, and demodulates radio signals received from other chips into data and transmits the data to the communication unit.

The chip may be a wired communication chip.

The radio communication unit may be connected to the communication unit in a wired manner.

The radio communication unit may separate from the chips.

The radio communication unit may include: a local oscillator that generates first and second local signals in a specific frequency band; a radio transmitter that converts data transmitted from the communication unit into radio signals and transmits the radio signals through an antenna; and a radio receiver that demodulates the radio signals received through the antenna into the data and transmits the data to the communication unit.

The radio communication unit may further include: a band pass filter unit that removes noise signals so as to transmit the radio signals received from the radio transmitter through the antenna and receives the radio signals received through the antenna to remove the noise signals; and a switch selecting whether the radio communication unit transmits or receives the radio signals.

The radio transmitter may include: a modulator that modulates the data to be transmitted using a first local signal to output an intermediate frequency signal; a first amplifier that amplifies the modulated intermediate frequency signal; a first mixer that up-converts a frequency using the amplified intermediate frequency signal and the second local signal to output the radio signals; and a power amplifier that amplifies the power of the radio signals.

The radio receiver may include: a second amplifier that receives and amplifies the radio signals passing through the band pass filter unit; a second mixer that down-converts a frequency by synthesizing the radio signals amplified in the second amplifier and the second local signal to output the intermediate frequency signal; an intermediate frequency amplifier that receives and amplifies an intermediate frequency signal output from the second mixer; a demodulator that demodulates the radio signals using the amplified intermediate frequency signal and the first local signal to output data.

The radio communication unit may be a buffer for radio communication.

### BRIEF DESCRIPTION OF THE DRAWINGS

FIG. 1 is a configuration diagram of an interface of a multi chip module according to a first exemplary embodiment of the present invention;

FIG. 2 is a configuration diagram of an interface of a multi chip module according to a second exemplary embodiment of the present invention;

FIG. 3 is a configuration diagram of an interface of a multi chip module according to a third exemplary embodiment of the present invention;

FIG. 4 is an inner configuration diagram of a radio communication unit according to an exemplary embodiment of the present invention; and

FIG. 5 is a configuration diagram of an interface of a memory multi chip module according to an exemplary embodiment of the present invention.

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Therefore, the configurations described in the embodiments and drawings of the present invention are merely most preferable embodiments but do not represent all of the technical spirit of the present invention. Thus, the present invention should be construed as including all the changes, equivalents, and substitutions included in the spirit and scope of the present invention at the time of filing this application.

Hereinafter, exemplary embodiments of the present invention will be described in detail with reference to the accompanying drawings.

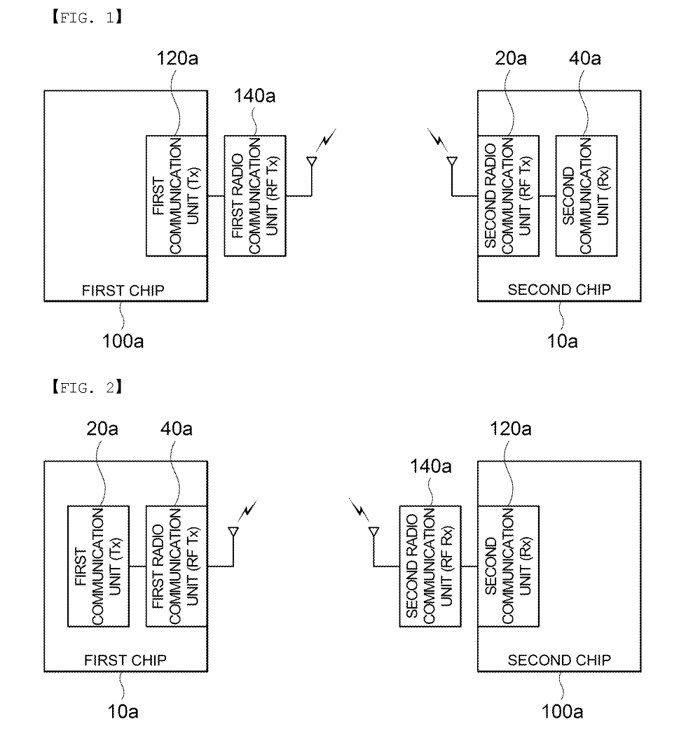

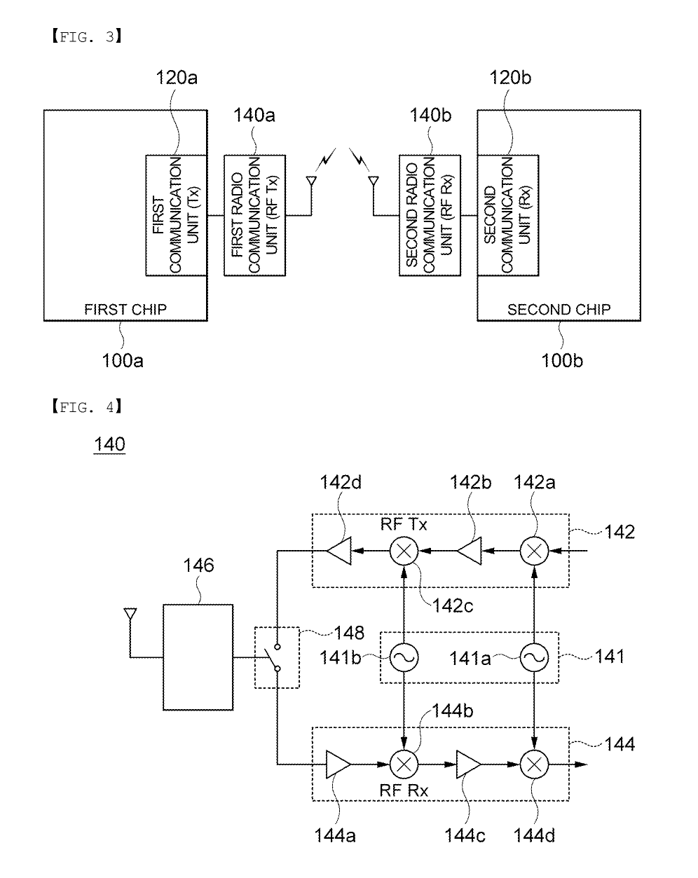

FIG. 1 is a configuration diagram of an interface of a multi chip module according to a first exemplary embodiment of the present invention, FIG. 2 is a configuration diagram of an interface of a multi chip module according to a second exemplary embodiment of the present invention, and FIG. 3 is a configuration diagram of an interface of a multi chip module according to a third exemplary embodiment of the present invention.

As shown in FIGS. 1 to 3, a multi chip module includes a plurality of chips. A plurality of chip interfaces are each configured to include a communication unit 120 and a radio communication unit 140.

In this case, the plurality of chips includes a wired communication chip 100 and a radio communication chip 10.

First, prior to describing the interface of a multi chip module according to the exemplary embodiment of the present invention, the wired communication chip 100 and the radio communication chip 10 will be briefly described. Generally, the wired communication chip 100 has the communication unit 120 therein. The communication unit 120 is connected to a communication unit of another wired communication chip in a wired manner using copper, thereby transmitting and receiving data. That is, the wired communication chip 100 is a chip without a radio communication device such as an antenna.

The radio communication chip 10 has a communication unit 20 and a radio communication unit 40 therein. The radio communication chip 10 wirelessly communicates with another radio communication chip through an antenna included in the radio communication unit 40 to transmit and receive data.

In this case, the radio communication unit 40 serves to convert data transmitted from the communication unit 20 into radio signals so as to be wirelessly transmitted or to demodulate the radio signals received from the antenna into data so as to be transmitted to the communication unit 20.

Referring back to FIGS. 1 to 3, the interface of the wired communication chip 100 includes the communication unit 120 and the radio communication unit 140.

The communication unit 120 is provided in a wired communication chip 103 to transmit and receive data.

The radio communication unit 140 is provided outside the wired communication chip 103. The radio communication unit 140 converts the data transmitted from the communication unit 120 into the radio signals so as to be wirelessly transmitted and demodulates the radio signals received from another chip through the antenna into data so as to be transmitted to the communication unit 120.

In addition, the radio communication unit 140 includes both of the radio transmitter 142 (RF Tx) and the radio receiver 144 (RF Rx) and thus, may selectively perform transmitting or receiving operation.

In FIG. 1, a first chip 100a, which is a wired communication chip, includes a first radio communication unit 140a that is connected to a first communication unit 120a and a first communication unit 120a in a wired manner to serve to convert data transmitted from the first communication unit 120a and to transmit the converted data and a second chip 10a receiving radio signals transmitted from the first radio communication unit 140 is a radio communication chip having both of the second communication unit 20a and the second radio communication unit 40a therein.

In FIG. 2, a first chip 10a, which is a radio communication chip, is configured to include a first communication unit 20a and a first radio communication unit 40a that converts data transmitted from the first communication unit 20a and a first radio communication unit 40a into radio signals and transmits the radio signals and the second chip 100a, which is a wired communication chip, is configured to include the second radio communication unit 140a and the second communication unit 120a that demodulate radio signals received through an antenna into data and transmit the data to the second communication unit 120a.

In FIG. 3, both of the first and second chips 100a and 100b are wired communication chips and the first and second chips 100a and 100b have the first and second communication units 120a and 120b therein and the first and second chips 100a and 100b are connected to first and second radio communication units 140a and 140b present at the outside thereof, which are connected to the first and second communication units 120a and 120b in a wired manner.

As described above, the existing wired communication chips may implement the radio communication among chips. That is, as shown in FIGS. 1 and 2, when the radio communication unit is included in any one of transmitting and receiving ends, the radio communication may be implemented when the radio communication unit is connected to the wired communication chip. In this case, the signal integrity (reflection, interference) that is the problem of the existing wired communication may be solved.

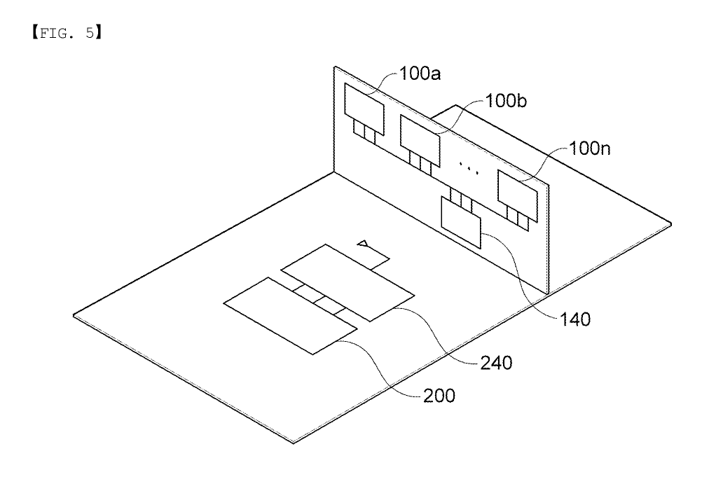

FIG. 4 is an inner configuration diagram of a radio communication unit according to an exemplary embodiment of the present invention.

Referring to FIG. 4, the radio communication unit 140 is configured to include a local oscillator 141, a radio transmitter 142 (RF Tx), a radio receiver 144 (RF Rx), a band pass filter unit 146, and a switch 148.

The local oscillator 141 is configured to include first and second local oscillators 141a and 141b that generate first and second local signals in a specific frequency band.

The radio transmitter 142 (RF Tx) converts data transmitted from the communication unit 120 into radio signals and transmits the radio signals through the antenna.

The above-mentioned radio transmitter 142 (RF Tx) is configured to include a modulator 142a, a first amplifier 142b, a first mixer 142c, and a power amplifier 142d.

The modulator 142a modulates the data to be transmitted using the first local signal, thereby outputting an intermediate frequency signal. That is, the modulator 142a converts an in-phase/quadrature-phase (I/Q) signal received from a digital to analog (D/A) converter (not shown) of a base band into an intermediate frequency signal using the first local signal that is generated from a first local oscillator 142a1.

The first amplifier 142b amplifies the modulated intermediate frequency signal.

The first mixer 142c up-converts a frequency by using the intermediate frequency signal amplified in the first amplifier 142b and the second local signal, thereby outputting the radio signals.

The power amplifier 142d amplifies the power of the radio signal.

The radio receiver 144 (RF Rx) demodulates the radio signals received through the antenna into data and transmits the data to the communication unit 120.

As described above, the radio receiver 144 is configured to include a second amplifier 144a, a second mixer 144b, an intermediate frequency amplifier 144c, and a demodulator 144d.

The second amplifier 144a receives and amplifies the radio signals that pass through the band pass filter unit 146.

The second mixer 144b down-converts a frequency by synthesizing the radio signals amplified in the second amplifier 144a and the second local signal generated from the second local oscillator 141b, thereby outputting the intermediate frequency signal.

The intermediate frequency amplifier 144c receives and amplifies the intermediate frequency signal output from the second mixer 144b.

The demodulator 144d demodulates the radio signals using the intermediate frequency signal amplified in the intermediate frequency amplifier 144c and the first local signal. That is, the demodulator 144d demodulates the radio signals using the intermediate frequency signal amplified in the intermediate frequency amplifier 144c and the first local signal and divides the demodulated radio signals into the in-phase (I) and the quadrature-phase (Q) signals so as to be output as a base band.

The band pass filter unit 146 removes noise signals so as to transmit the radio signals received from the radio transmitter 142 through the antenna and receives the radio signals received through the antenna to remove the noise signals.

The switch 148 selects whether to transmit the radio signals received from the radio transmitter 142 using the band pass filter unit 146 and the antenna or to receive the radio signals received from the antenna through the band pass filter unit 146. That is, the switch 148 selects whether the radio communication unit 140 is operated in a transmitting or receiving mode.

Meanwhile, the exemplary embodiment of the present invention is implemented to allow the radio communication unit 140 to perform both of the transmitting and receiving operations but may be implemented to allow the radio communication unit to perform only the transmitting operation or the receiving operation. Further, it is apparent that the radio communication unit 140 may be implemented using various radio communication technologies.

FIG. 5 is a configuration diagram of an interface of a memory multi chip module according to an exemplary embodiment of the present invention.

Referring to FIG. 5, according to the related art, a method of connecting a memory controller to memory chips on a main board in a wired manner is used However, as the transmission rate of data is increased, problems such as transmission loss of a copper wiring, discontinuity of a connector, crosstalk between signals, or the like, occur.

In order to solve the above problems, when an interface of a memory multi chip module uses the radio communication, both of the memory controller and the memory chips are to be designed and manufactured for radio communication. For example, when the memory chips are manufactured for radio communication but the memory controller is not manufactured for the radio communication, the interface of a memory multi chip module cannot use the radio communication.

Therefore, in order to allow the existing wired communication chips to perform the radio communication, as shown in FIG. 5, when the radio communication units 240 and 140 are connected to a memory controller 200 and memory chips 100 in a wired manner, the radio communication interface may be implemented using the existing chips without redesigning the memory controller 200 and the memory chips 100.

In addition, it is possible to connect a single radio communication unit 140 (a buffer for radio communication) to a single memory chip 100 and to implement the single radio communication unit 140 on a plurality of memory chips 100a to 100n.

As set forth above, the interface of a multi chip module according to the exemplary embodiment of the present invention can allow the wired communication chips to implement the radio communication among the plurality of chips.

That is, the exemplary embodiment of the present invention can implement the radio communication among the plurality of chips by installing the radio communication unit (a buffer for radio communication) capable of allowing the wired communication chips to perform the radio communication.

In addition, the exemplary embodiment of the present invention can solve the problem of the signal integrity (reflection, interference) by allowing the wired communication chips to implement the radio communication.

While the present invention has been shown and described in connection with the exemplary embodiments, it will be apparent to those skilled in the art that modifications and variations can be made without departing from the spirit and scope of the invention as defined by the appended claims.

What is claimed is:

1. An interface of a multi chip module transmitting and receiving data among a plurality of chips, comprising:
a communication unit that is provided in the chips and transmits and receives the data; and
a radio communication unit that is provided outside the chips, converts the data transmitted from the communication unit into radio signals and wirelessly transmits the radio signals, and demodulates radio signals received from other chips into data and transmits the data to the communication unit.

2. The interface of a multi chip module according to claim 1, wherein the chip is a wired communication chip.

3. The interface of a multi chip module according to claim 1, wherein the radio communication unit is connected to the communication unit in a wired manner.

4. The interface of a multi chip module according to claim 1, wherein the radio communication unit separates from the chips.

5. The interface of a multi chip module according to claim 1, wherein the radio communication unit includes:
a local oscillator that generates first and second local signals in a specific frequency band;
a radio transmitter that converts data transmitted from the communication unit into radio signals and transmits the radio signals through an antenna; and
a radio receiver that demodulates the radio signals received through the antenna into the data and transmits the data to the communication unit.

6. The interface of a multi chip module according to claim 5, wherein the radio communication unit further includes:
a band pass filter unit that removes noise signals so as to transmit the radio signals received from the radio transmitter through the antenna and receives the radio signals received through the antenna to remove the noise signals; and
a switch selecting whether the radio communication unit transmits or receives the radio signals.

7. The interface of a multi chip module according to claim 6, wherein the radio transmitter includes:
a modulator that modulates the data to be transmitted using a first local signal to output an intermediate frequency signal;
a first amplifier that amplifies the modulated intermediate frequency signal;
a first mixer that up-converts a frequency using the amplified intermediate frequency signal and the second local signal to output the radio signals; and
a power amplifier that amplifies the power of the radio signals.

8. The interface of a multi chip module according to claim 6, wherein the radio receiver includes:
a second amplifier that receives and amplifies the radio signals passing through the band pass filter unit;
a second mixer that down-converts a frequency by synthesizing the radio signals amplified in the second amplifier and the second local signal to output the intermediate frequency signal;
an intermediate frequency amplifier that receives and amplifies an intermediate frequency signal output from the second mixer; and
a demodulator that demodulates the radio signals using the amplified intermediate frequency signal and the first local signal to output data.

9. The interface of a multi chip module according to claim 1, wherein the radio communication unit is a buffer for radio communication.
